(19) United States
(12) Patent Application Publication
(10) Pub. No.: US 2010/0284734 A1
(43) Pub. Date: Nov. 11, 2010

(54) INTERLOCKING ASSEMBLY SYSTEM

(75) Inventors: Edward Charles Turnour, Camp Hill QLD (AU); Neville John Sherlock, Coorparoo QLD (AU)

Correspondence Address: CONLEY ROSE, P.C.;David A. Rose, P. O. BOX 3267, HOUSTON, TX, 77253-3267, US

(73) Assignee: TERN (QLD) PTY LTD, Underwood QLD, AU (AU)

(21) Appl. No.: 12/747,208

(22) PCT Filed: Dec. 17, 2008
(86) PCT No.: PCT/AU2008/001856

§ 371 Date: Jun. 10, 2010

(30) Foreign Application Priority Data
Dec. 17, 2007 (AU) 2007906902

(51) Int. Cl. F16B 7/04

(52) U.S. Cl. 403/291; 29/525.01

(57) ABSTRACT

An interlocking assembly system and method including an interlocking member (100) configured for insertion into a slot (22) of a tube (20), which is in turn connectable to a bracket (10). In use, slats or other pieces may be inserted into the trailing end of the interlocking member (100) and tube (20) to provide a more stable and easier to assemble structure. Applications include fencing, privacy screens, awnings, lourvre or balustrades.

### FIELD OF THE INVENTION

The present invention relates to improvements in the attachment of pieces of fencing, privacy screen, awning, louvre or balustrade assemblies.

### BACKGROUND OF THE INVENTION

Conventional assemblies often require an inordinate amount of time to assemble, at least partially due to the various attachments and parts needed to attach various pieces together. Accordingly, there exists a need to provide an improved system and method which permits a greater ease of assembly with fewer parts.

### SUMMARY

The present invention in one preferred aspect provides for a system for connecting together pieces of an assembly such as a fencing, privacy screen, awning, louvre or balustrade. In particular, the present invention in one preferred aspect provides for an interlocking member for attaching two pieces of a fencing, privacy screen, awning, louvre or balustrade assembly together, the interlocking member comprising a body having an insertion end, a trailing end, a central longitudinal axis from the insertion end to the trailing end, and a wall extending between the insertion and trailing ends. The wall includes an interior surface oriented toward the central longitudinal axis and an exterior surface oriented away from the central longitudinal axis, the wall including a flexible tab configured to interdigitate with one of the pieces of the assembly to secure the body thereto, the tab being integrally formed with the body, the body being adapted to be secured to another of the pieces to securely connect the two pieces of the assembly together.

In another preferred aspect, the present invention provides for a system for attaching two pieces of a fencing, privacy screen, awning, louvre or balustrade assembly together, the system including an interlocking member having an insertion end, a trailing end and a central longitudinal axis from the insertion end to the trailing end, the trailing end including an opening; a first piece of the assembly having an opening configured to receive the interlocking member; and a second piece of the assembly having an end configured to be received within a portion of the trailing end of the interlocking member, the interlocking member having an integrally formed attachment means configured to interdigitate with the first and second pieces of the assembly to securely connect the first and second pieces together.

In another preferred aspect, the present invention provides for a method of assembling together pieces of outdoor items such as a fencing, privacy screen, awning, louvre or balustrade. In particular, the present invention in one preferred aspect provides for a method for attaching first and second pieces of a fencing, privacy screen, awning, louvre or balustrade assembly together, each of the pieces having a central longitudinal axis, the method including inserting an interlocking member into a portion of the first piece of the assembly until the interlocking member snaps into engagement with the first piece; and inserting a portion of the second piece of the assembly into a portion of the interlocking member and the first piece of the assembly until the second piece snaps into engagement with the interlocking member.

Preferably the assemblies or outdoor items may include sub-assemblies such as wings, gates, slats or flaps, which may have having a sliding, hinged or folding relation with the fencing, screen, louvre or balustrade.

### BRIEF DESCRIPTION OF THE FIGURES

FIG. 1 is a top plan view of an interlocking member in accordance with a preferred embodiment of the present invention.

FIG. 2 is a partial cross sectional side elevation view of the interlocking member of FIG. 1.

FIG. 2A is an expanded view along section A of FIG. 2.

FIG. 3 is an expanded partial cross sectional side view of the interlocking member of FIG. 1.

FIG. 4 is an expanded top plan view of the interlocking member of FIG. 1.

FIG. 5 is a side perspective view of a bracket in accordance with a preferred embodiment of the present invention.

FIG. 6 is a front view of the bracket of FIG. 5.

FIG. 7 is a top plan view of the bracket of FIG. 5.

FIG. 8 is a partial top plan view of an assembly piece shown in a direction of insertion into a portion of the bracket of FIG. 5.

FIG. 9 is a perspective view of a profile piece shown being inserted over a portion of the bracket of FIG. 5.

FIG. 10 is a perspective view of the interlocking member of FIG. 1 shown being inserted into the profile piece of FIG. 9, which is shown being inserted into the bracket of FIG. 5.

FIG. 11 is a perspective view of the profile piece and bracket of FIG. 9 connected together.

FIG. 12 is a side perspective view of a bracket in accordance with another preferred embodiment of the present invention.

FIG. 13 is a side elevation view of a bracket in accordance with another preferred embodiment of the present invention.

FIG. 14 is a perspective view of the bracket of FIG. 11 shown in hidden lines within two pieces of an assembly.

FIG. 15 is a side elevation view of an interlocking member in accordance with another preferred embodiment of the present invention.

FIG. 16 is an end view of the interlocking member of FIG. 15.

FIG. 16A is an expanded side view of the interlocking member of FIG. 15.

FIG. 17 is a bottom view of the interlocking member of FIG. 15.

FIG. 18 is a top perspective view of an interlocking member in accordance with another preferred embodiment of the present invention.

FIG. 19 is a side perspective view of the interlocking member of FIG. 18.

FIG. 20 is a side elevation view of the interlocking member of FIG. 18.

FIG. 21 is a top plan view of the interlocking member of FIG. 18.

FIG. 22 is an end view of the interlocking member of FIG. 18.

FIG. 23 is a schematic view of a method according to one preferred embodiment of the present invention.

FIG. 24 is a schematic view of the method of FIG. 23 with the interlocking member shown inserted into a profile assembly piece.

FIG. 25 is a schematic view of the method of FIG. 23 with a slat assembly piece shown inserted into the interlocking member.

### DETAILED DESCRIPTION OF THE DRAWINGS

Alternative embodiments of the invention will be apparent to those skilled in the art from consideration of the specification and practice of the invention disclosed herein. It is intended that the specification and examples be considered as exemplary only, with a true scope and spirit of the invention being indicated by the claims which follow. Wherever possible, like numbers will refer to like parts.

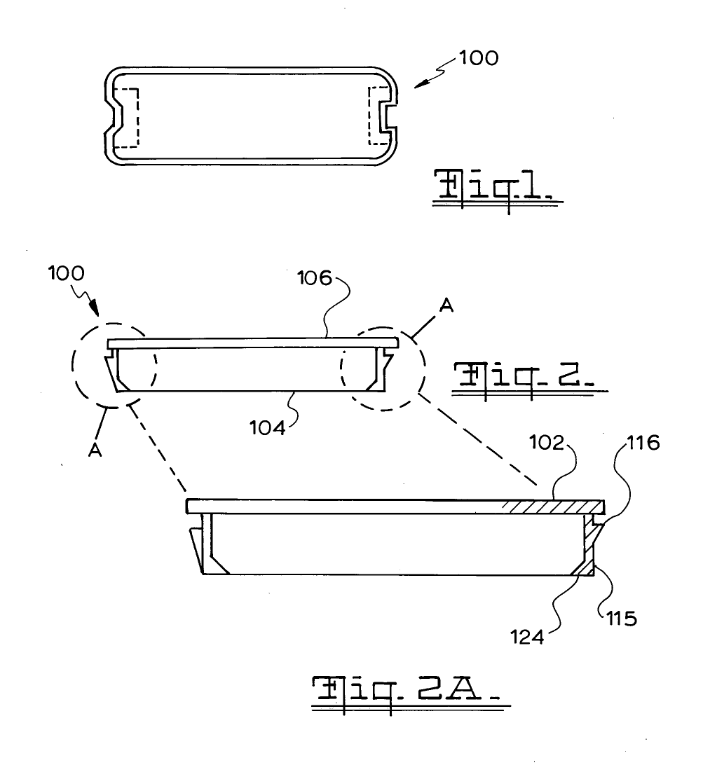

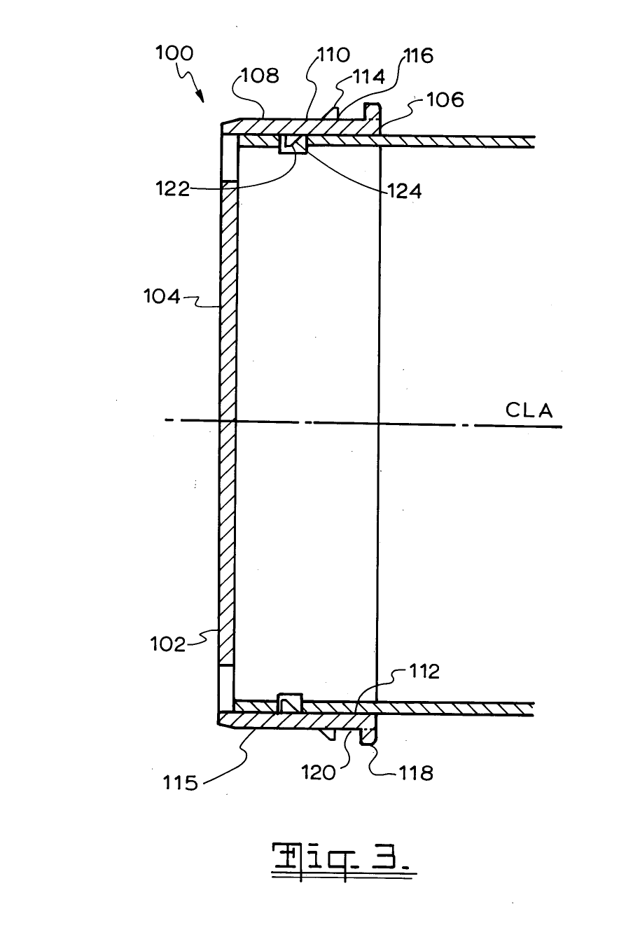

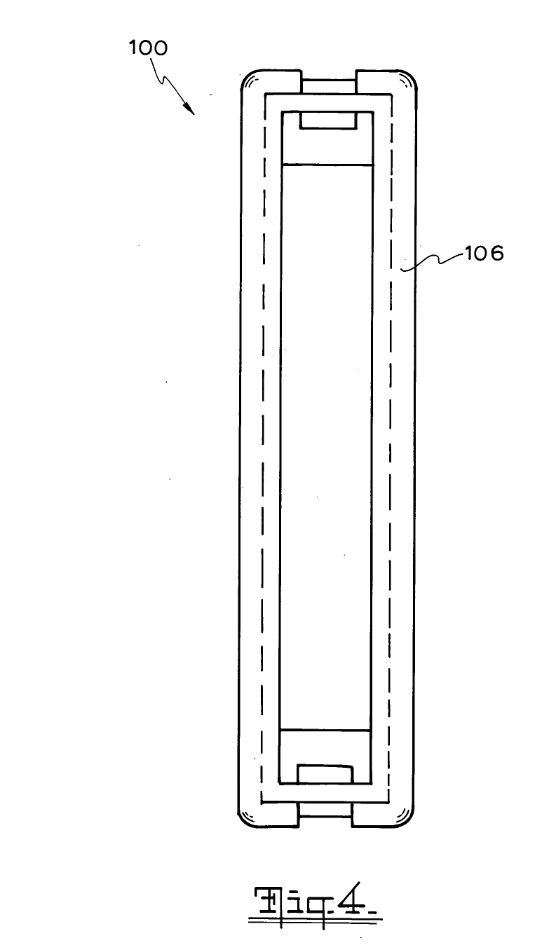

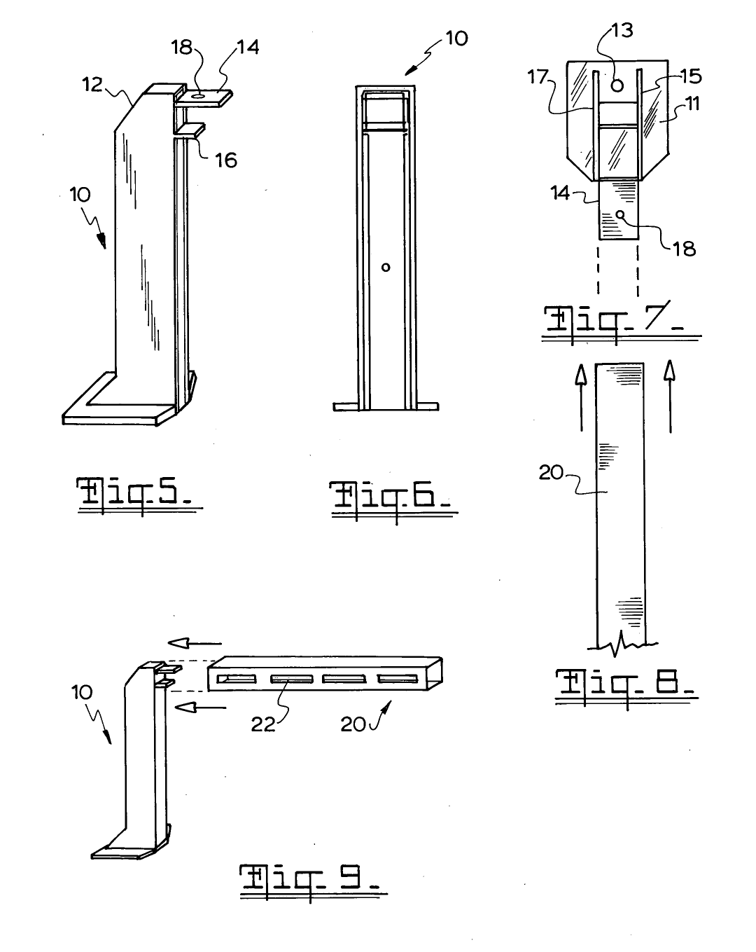

FIGS. 1 to 10 show a preferred embodiment of an interlocking member or plug 100, a support brace or bracket 10 and slotted arm piece 20 of outdoor assembly such as, but not limited to fencing, privacy screen, awning, louvre or balustrade. The preferred elements of the system and their interrelationship are described below.

FIGS. 1 to 4 show a preferred embodiment of interlocking member or plug 100 having a body 102 with a first or leading end 104, a second or trailing end 106, and a central longitudinal axis CLA from the leading end to the trailing end. Body 102 of interlocking member 100 includes a wall 108 having a length along the CLA and an exterior surface 110 and an interior surface 112. Exterior surface 110 preferably includes attachment means 114 which in a preferred form include a tab 115 having one or more projections 116. In the example of FIGS. 2 and 2A, projections 116 are preferably shaped as a ratchet. It will be appreciated that attachment means 114 may be formed in a variety of ways. For example, attachment means 114 may include a groove, notches, a spring lock, tab, dimples, and other structures configured to interact or interdigitate with another corresponding piece. Exterior surface 110 further preferably includes a depth limiting means preferably formed as a lip 118. Projection 116 and lip 118 together preferably form a notch 120 sized to receive a portion of a piece of an assembly such as, but not limited to a fencing, privacy screen, awning, louvre or balustrade.

The internal surface 112 of body 102 preferably includes an attachment means 122 preferably formed as one or more surface projections 124. When in use, surface projections 116 and lip 118 together fix body 102 to a first piece of an assembly while surface projections 124 and a portion of interior surface proximate leading end 104 preferably cooperate to secure a second piece of the assembly within body 102. Attachment means 122 may be formed in a variety of ways, for example, such as those mentioned with reference to attachment means 114.

Trailing end 106 preferably forms an opening into which a portion of another piece of the assembly may be inserted. Interior surface 112 may include grooves or projections configured for increasing the resistance of a piece inserted into the interior of the interlock member from being withdrawn. Such grooves and/or projections may be longitudinal or otherwise configured as appropriate.

Preferably, tab 115 is formed as a generally flexible portion extending from trailing end 106 and is separated from other wall portions of body 102 along the length of the tab. As shown in FIG. 2A, projection 116 is ramped for allowing a snap fit locking of interlocking member 100 into a piece of the assembly. Projection 124 is preferably ramped for allowing a snap fit locking of another piece of the assembly into interlocking member 100. Forming interlocking member 100 with projections on the exterior and interior surfaces of the plug beneficially permits a double snap fit lock of two pieces of an assembly to one another.

Interlocking member 100 may be formed in a variety of shapes and sizes. For example only, interlocking member 100 may have the cross sectional shape of a polygon such as a square or rectangle, or a curved cross sectional shape such as a circle or oval, or any combination thereof. In general, the cross sectional shape is preferably matched to the general cross sectional shape of one of the pieces of the assembly with which it is intended for use.

Interlocking member 100 may be made of a variety of materials. For example, interlocking member 100 may be formed from a metallic material and/or plastic material as desired. The material is preferably chosen to withstand a reasonable amount of weathering. Forming interlocking member 100 from a plastic material advantageously allows for a degree of expansion between pieces of the assembly, permitting the connection between the assembly pieces to remain substantially stable in changing weather conditions.

FIGS. 5 to 7 and 10 show a bracket 10 having an integral U-shaped section with an angled rear portion 12, an upper surface 14 and a lower surface 16. Upper surface 14 preferably includes an opening 18 configured to receive a fastener such as a screw. Upper and lower surfaces 14, 16 are preferably oriented to be in a parallel, horizontal configuration. Such an orientation permits a piece such as slotted piece 20 to be slid over the surfaces with an alignment of slot 22 between the upper and lower surfaces. The clearance between the surfaces is preferably such as to allow the insertion of interlocking member 100 into slot 22 and between the upper and lower surfaces, as shown in FIGS. 7 to 11 and further described below.

FIG. 7 shows a top view of bracket 10. Bracket 10 preferably includes a foot plate 11 with a screw hole 13 for mounting on a wall or other structure, or a ground surface, and a pair of rearward projecting flanges 15, 17.

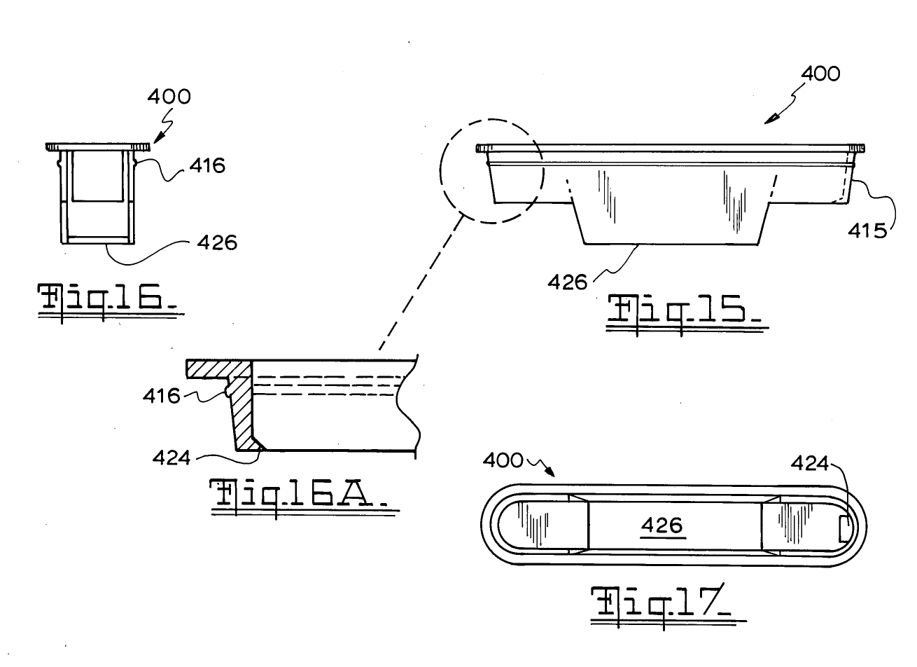

It will be appreciated that the connection end of bracket 10 may be configured in ways other than a U-shaped section, or have a U-shaped section at a different orientation (for example, with parallel, vertical surfaces) if desired. Preferably, the U-shaped section is integral with bracket 10. However, the U-shaped section may form part of a stand-alone connection bracket piece such as shown in FIGS. 12 and 14 and described further below.

Referring to FIGS. 12 and 14, bracket 200 is shown in accordance with another preferred embodiment of the present invention. Bracket 200 is preferably a configured as a connection piece insertable into a brace configured similar to bracket 10, or another piece or profile of the assembly. Bracket 200 has a preferably L-shaped body 202 with a first section 204, a second, intermediate section 206, and a third section 208. First section 204 includes an exterior side surface 210 that is preferably configured to slideably engage within a piece 30 of an assembly, such as shown in FIG. 14. The cross section of first section 204 is preferably reduced relative to that of second section 206 so that when piece 30 is attached to bracket 200, the exterior surface of piece 30 is generally flush with the exterior surface of second section 206 (see FIG. 14).

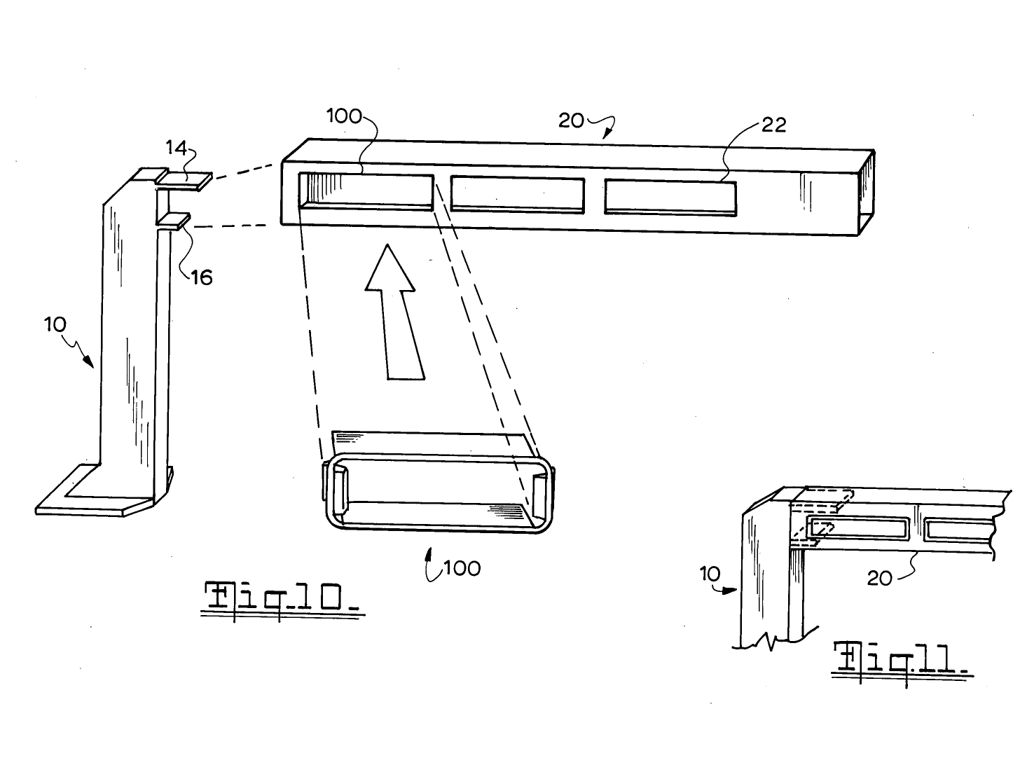

As shown in FIG. 12, third section 208 preferably includes a generally U-shaped portion with an upper portion 212 connected to a lower portion 214 by a base 216. The overall cross sectional dimension of third section 208 is reduced relative to that of second section 206. Preferably, third section 208 is shaped and configured to slide within a piece of an assembly, such as slotted piece 20 shown in FIGS. 14 and 10.

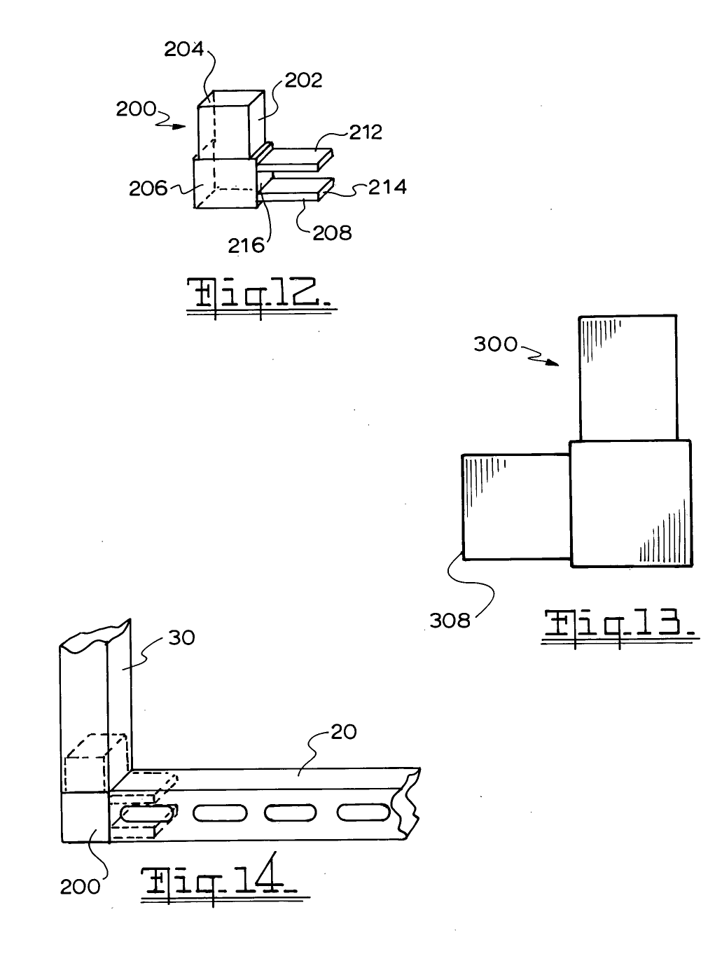

First section 204 and third section 208 are preferably oriented at a 90 degree angle relative to one another (see, e.g., FIG. 13). It will be appreciated that other angles are within the scope of the present invention. Additionally, the cross sections of each section may be varied and formed as square, rectangular, circular, oval, or any other shape suitable for the intended use. For example, the bracket may have a first section angularly configured for insertion into one end of the brace. Such an angled section may include a surface configured to resist vertical movement along the angled surface to enhance the stability of the structure.

FIG. 13 shows a bracket 300 in accordance with another preferred embodiment of the present invention. Bracket 300 is similar to bracket 200 except that instead of a generally U-shaped section, bracket 300 includes a solid third section 308.

FIGS. 15 to 17 show an interlocking member 400 in accordance with another preferred embodiment of the present invention. Interlocking member 400 is similar to interlocking member 100 except that interlocking member 400 has a generally rounded or oval outer profile. Additionally, interlocking member 400 preferably includes only a single end tab 415 having a projection 424 on its internal surface. Projection 424 is preferably formed as a ratchet. Interlocking member preferably includes a projection 416 in the form of an annular rib positioned proximate the trailing end of interlocking member 400. Interlocking member 400 further preferably includes a bar gate 426 at its leading end as a further depth limiting means for insertion of an assembly piece therein. Bar gate 426 may also beneficially assist in the guidance of interlocking member 400 into a piece of the assembly.

FIGS. 18 to 21 show an interlocking member 500 in accordance with another preferred embodiment of the present invention. Interlocking member 500 is similar to interlocking member 400 except that tab 515 has a projection 524 positioned approximately halfway along its length between the leading and trailing ends of interlocking member 500. As shown in FIG. 19, tab 515 extends a majority of the length of the interlocking member and has a base proximate projection 516, preferably formed as an annular rib.

Having described the preferred components of the interlocking member and bracket, a preferred method of use will now be described with reference to FIGS. 9 to 11. In a preferred embodiment, the present invention permits easy interlocking attachment of pieces of an assembly such as, but not limited to fencing, privacy screen, awning, louvre or balustrade. As shown in FIG. 9, a user may attach a slotted profile piece 20 into one end of bracket 10. The generally U-shaped configuration of bracket 10 cooperates with slots 22 of slotted piece 20 to receive leading end 104 of interlocking member 100 therein.

Preferably the user will insert an end of another piece of the assembly into interlocking member 100 until a cooperating surface of the piece engages attachment means 122. The user may then move interlocking member 100 and the piece attached thereto toward a piece such as slotted piece 20, inserting leading end 104 into one of slots 22 until the engagement of projections 116 with the perimeter of the slot. The engagement of projections 116 with the perimeter of slot 22 causes a compression of leading end 104 such that the projections slide within the perimeter of the slot and resiliently re-form their original position, in effect completing a snap fit lock between interlocking member 100 and slotted piece 20. Additional pieces of the assembly may be attached in like manner until the assembly is completed.

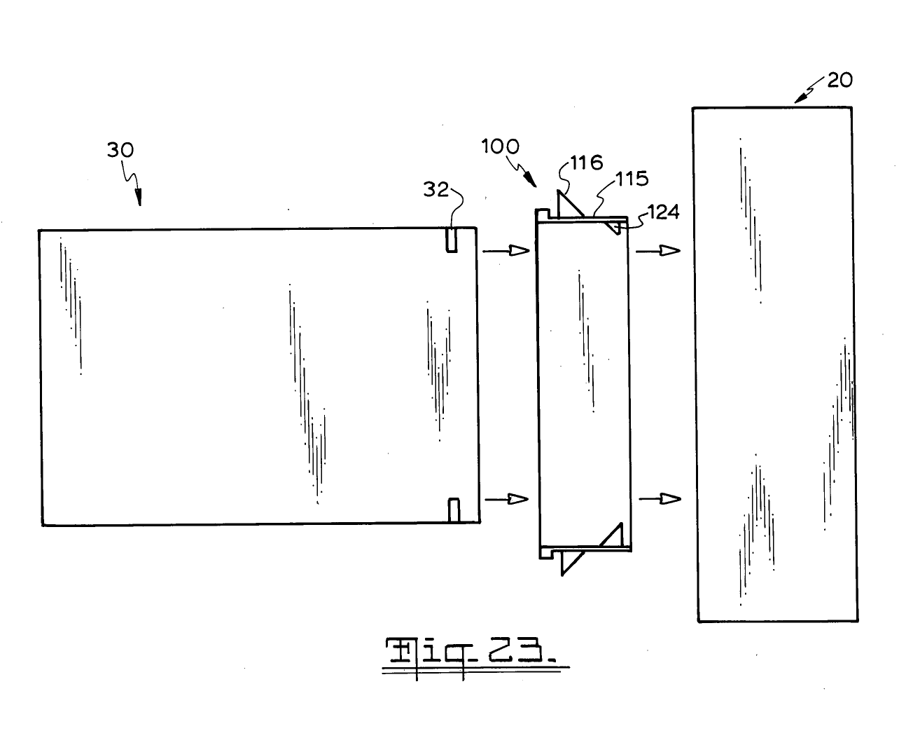

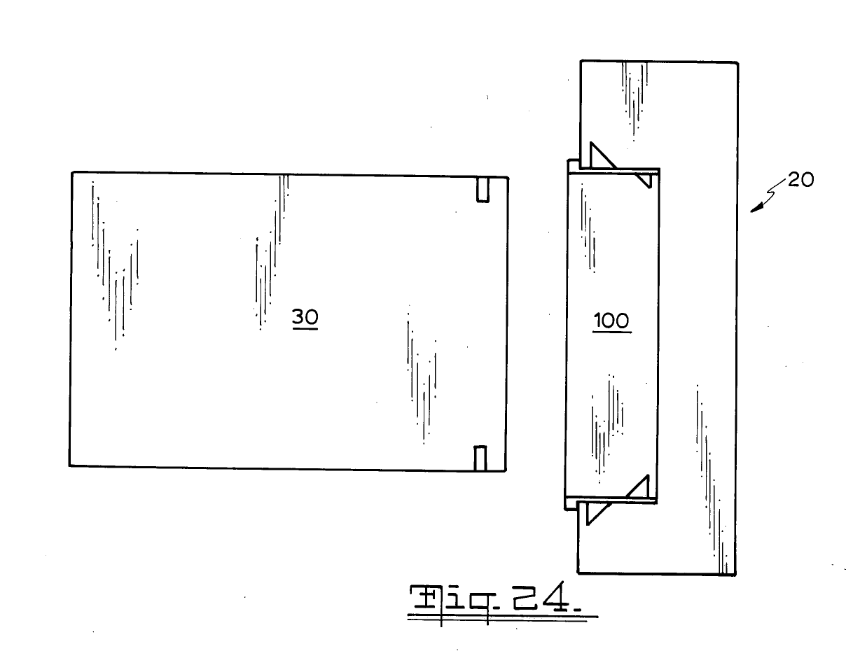

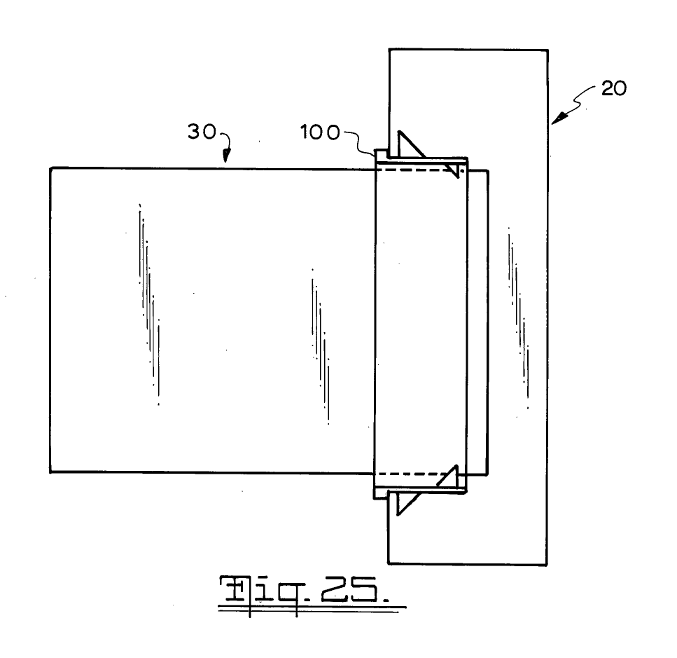

FIGS. 23 to 25 show an exemplary method of attaching a slat 30 to a tube profile (such as slotted piece 20 shown in FIG. 9). In FIGS. 23 and 24, interlocking member (or plug) 100 is inserted into tube profile 20 until projections 116 engage into corresponding notch within tube profile 20, and the lip at the trailing end engages the exterior surface of the tube profile. Thereafter, slat 30 is inserted into the opening in the trailing end of interlocking member 100 until recesses 32 of slat 30 (FIG. 23) engage with ratchets 124 in the interior surface of interlocking member 100, as shown in FIG. 25. The tube profile may be configured similar to slotted piece 20 shown in FIG. 9, or may be otherwise configured, for example, a fence post. It will be understood that tube profile 20 and/or slat 30 may have a variety of cross sectional shapes without departing from the scope of the present invention, for example only, circular, oval, square, rectangular, etc. Interlocking member 100 may be configured to have a shape corresponding to the shape of the slat and/or profile piece as desired.

It will be appreciated that the steps described above may be performed in a different order, varied, or omitted entirely without departing from the scope of the present invention.

The snap fit locking arrangement of the embodiment described above has the advantage of permitting a user to quickly assemble pieces of fencing, privacy screen, awning, louvre or balustrade. The snap locking arrangement also minimises the risk of parts being lost.

In some embodiments, the outdoor assemblies may include sub-assemblies such as movable, adjustable or opening components such as wings, gates, slats or flaps having a sliding, hinged or folding relation with the fencing, screen, louvre or balustrade.

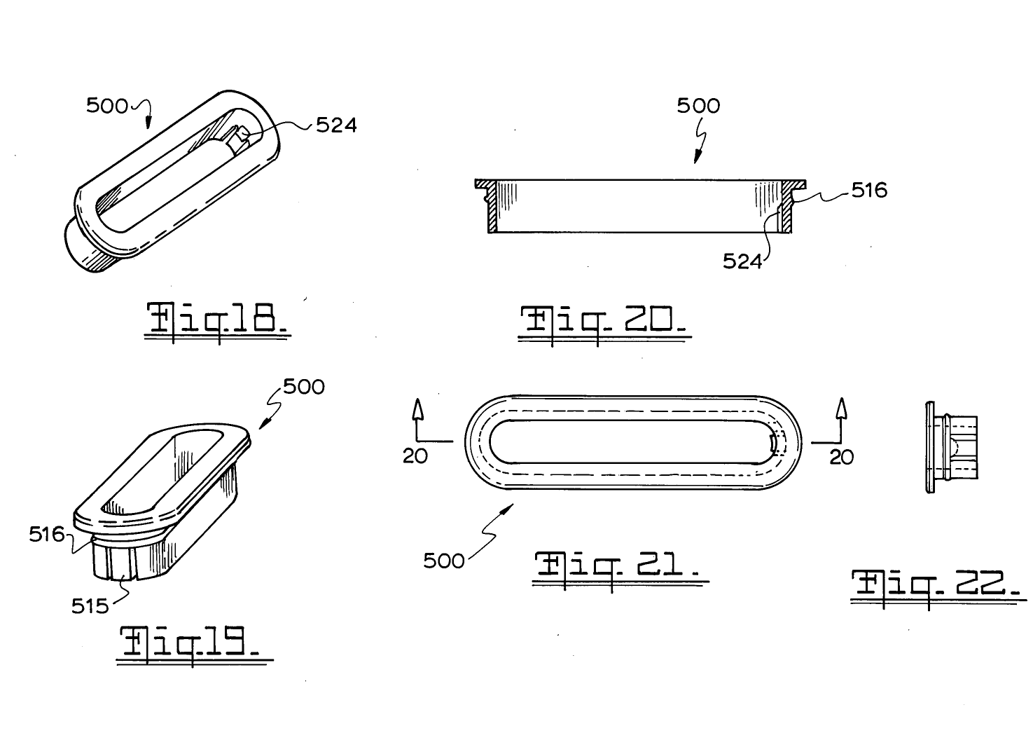

The foregoing description is by way of example only, and may be varied considerably without departing from the scope of the present invention. For example only, the snap lock arrangement described in relation to FIGS. 1 to 4 may be used with the bracket to attach pieces of the assembly together. The snap lock arrangement may be used in addition to or in place of other fastening means such as the screws already described. Other suitable fastening means include, but is not limited to rivets, bolts, a friction fit configuration, spring locks and one-way insertion ratcheting. As may be seen for example from the embodiments shown in FIGS. 1, 15 and 19, the exterior surface of the interlocking member may include one or more projections in the form of a ratchet or rib, or no projections if so desired. The internal surface of the interlocking member may include one or more projections. The projections of the external and internal surfaces may be oppositely positioned (similar to that shown in FIG. 20), and/or differently positioned along the length of the interlocking member (similar to that shown in FIG. 2A). The projections of the interior and/or exterior surfaces of the interlocking member may be positioned at one end or side only (similar to that shown in FIG. 19), oppositely oriented (similar to that shown in FIG. 2A), or at 90 degrees relative to each other (e.g., an external rib on the upper and lower wall portions with internal ratchets on the end portions of the wall). A variety of combinations are possible and envisaged.

The interlocking member may be omitted by configuring one end of a piece of the assembly for direct lockable engagement with another piece. Such a configuration may include attachment means along the exterior surface such as described above in relation to interlocking member 100.

The features described with respect to one embodiment may be applied to other embodiments, or combined with or interchanged with the features other embodiments, as appropriate, without departing from the scope of the present invention.

The present invention in a preferred form provides the advantages of ease of assembly, a reduction in parts, and a cost savings when compared to conventional assemblies. Some conventional assemblies include spring lock attachments. The integral, flexible attachment means such as described above provides a more reliable and easier to use application that is better suited for outdoor applications, where adverse weather conditions may affect the workings of any attachment mechanisms. The provision of an insertion sleeve, as embodied by, for example, the interlocking member, beneficially provides a more stable structure that is adaptable to changing weather conditions for outdoor applications.

It will of course be realised that the above has been given only by way of illustrative example of the invention and that all such modifications and variations thereto as would be apparent to persons skilled in the art are deemed to fall within the broad scope and ambit of the invention as herein set forth.

1. An interlocking member for attaching two pieces of a fencing, privacy screen, awning, louvre or balustrade assembly together, the interlocking member comprising:
a body having an insertion end, a trailing end, a central longitudinal axis from said insertion end to said trailing end, and a wall extending between said insertion and trailing ends, said wall including an interior surface oriented toward the central longitudinal axis and an exterior surface oriented away from the central longitudinal axis, said wall including a flexible tab configured to interdigitate with one of the pieces of the assembly to secure said body thereto, said tab being integrally formed with said body, said body being adapted to be secured to another of the pieces to securely connect the two pieces of the assembly together, wherein said tab includes a projection extending from said interior surface of said wall in a direction toward the central longitudinal axis.

2. The interlocking member of claim 1, wherein said projection is positioned proximate said insertion end.

3. The interlocking member of claim 1, wherein said wall includes a projection extending from said exterior surface of said wall in a direction away from the central longitudinal axis.

4. The interlocking member of claim 3, wherein said projection extending from said exterior surface is positioned proximate said trailing end.

5. The interlocking member of claim 3, wherein said projection extending from said exterior surface is located on said tab.

6. The interlocking member of claim 1, wherein said projection is a ratchet.

7. The interlocking member of claim 1, further comprising a depth limiting means configured to limit the depth of said interlocking member into one of the pieces.

8. The interlocking member of claim 7, wherein said depth limiting means is a lip positioned proximate said trailing end.

9. The interlocking member of claim 1, further comprising a depth limiting means configured to limit the insertion of one of the pieces into said body.

10. The interlocking member of claim 9, wherein said depth limiting means configured to limit the insertion of one of the pieces into said body is a wall portion positioned proximate said leading end.

11. The interlocking member of claim 1, wherein said body is substantially made of a plastic material.

12. The interlocking member of claim 1, wherein said wall has a length along the central longitudinal axis and a width perpendicular to the central longitudinal axis, the width of said wall being greater than the length of said wall.

13. The interlocking member of claim 12, wherein said flexible tab has a length less than the length of another portion of said wall.

14. The interlocking member of claim 1, wherein said body includes a second flexible tab opposite said flexible tab.

15. The interlocking member of claim 1, wherein said body is configured as a sleeve for insertion into one of the pieces of the assembly.

16. A system for attaching two pieces of a fencing, privacy screen, awning, louvre or balustrade assembly together, the system including:
an interlocking member having an insertion end, a trailing end and a central longitudinal axis from said insertion end to said trailing end, said trailing end including an opening;
a first piece of the assembly having an opening configured to receive said interlocking member; and
a second piece of the assembly having an end configured to be received within a portion of said trailing end of said interlocking member, said interlocking member having an integrally formed attachment means configured to interdigitate with said first and second pieces of said assembly to securely connect said first and second pieces together.

17. The system of claim 16, wherein said attachment means includes a flexible tab.

18. The system of claim 17, wherein said tab includes a ratchet on an interior surface of said tab and a ratchet on an exterior surface of said tab.

19. The system of claim 16, wherein said first piece includes a plurality of openings, each opening configured to receive said interlocking member.

20. The system of claim 16, further comprising a bracket for attaching two pieces of the assembly together, the bracket including:
a first section having a longitudinal central axis and a cross section;
a second section having a longitudinal central axis and a cross section; and
a third portion having a longitudinal central axis and a cross section, the cross section of said first and third portions being different from the cross section of said second portion, the longitudinal central axes of said first and third portions being at an angle relative to one another, said first and third portions being adapted for cooperative engagement with the pieces of the assembly.

21. A method for attaching first and second pieces of a fencing, privacy screen, awning, louvre or balustrade assembly together, each of the pieces having a central longitudinal axis, the method including:
inserting an interlocking member into a portion of the first piece of the assembly until the interlocking member snaps into engagement with the first piece; and
inserting a portion of the second piece of the assembly into a portion of the interlocking member and the first piece of the assembly until the second piece snaps into engagement with the interlocking member.

22. The method of claim 21, wherein the step of inserting the interlocking member includes inserting a majority of the interlocking member into the portion of the first piece of the assembly.

23. The method of claim 21, further comprising attaching one of the pieces of the assembly to a bracket having two parallel flanges.

24. The method of claim 23, further comprising locking the piece of the assembly to the bracket.

25. The method of claim 24, wherein the step of locking includes inserting a screw through a portion of the first piece and at least one of the flanges of the bracket.
